(19) United States
(12) Patent Application Publication
(10) Pub. No.: US 2012/0145761 A1
(43) Pub. Date: Jun. 14, 2012

(54) Q bino stand

(76) Inventor: Bourbon Quijano, La Palma, CA (US)

(21) Appl. No.: 13/373,906

(22) Filed: Dec. 5, 2011

Related U.S. Application Data
(60) Provisional application No. 61/458,939, filed on Dec. 3, 2010.

(51) Int. Cl. B60R 7/06

(52) U.S. Cl. 224/483

(57) ABSTRACT

The invention provides a lightweight, adjustable support and stabilizing device, designed to support and stabilize binoculars, monoculars, cameras, and camcorders when used from within a motor vehicle. The Q Bino Stand comprises a telescopic stand that expands to different lengths and can be used inside a vehicle, from the driver's seat or passenger's seat, or from the back seat. The rear portion of the stand sits, yoke-like, with an inner width of approximately ten inches, on the user's shoulders. From the shoulders, the stand extends forward in two parallel rails that are joined by a cross-member, at the front end, this end designed to rest on the steering wheel or dashboard or, if the device is to be used from a rear seat, on the headrest of the seat in front.

### CLAIM OF PRIORITY

This patent application claims priority under 35 USC 119 (e) (1) from U.S. Provisional Patent Application Ser. No. 61/458,939, filed Dec. 3, 2010, of common inventorship herewith entitled, “Q Bino Stand.”

### FIELD OF THE INVENTION

The present invention pertains to the field of surveillance accessories and more specifically to the field of support systems for optical devices such as binoculars.

### BACKGROUND OF THE INVENTION

The prior art has put forth several designs for support systems for optical devices. Among these are:

U.S. Pat. No. 2,316,164 to Aaron H. Hoffeditz describes a face support for binoculars comprising a face piece which conforms to the lineaments of the user's face around the forehead, eyes and nose.

U.S. Pat. No. 2,357,377 to William Bausch describes an optical instrument support to hold binoculars and field glasses in operative position before the eyes of the user comprising a bracket for fitting over the head of the user and a shelf for receiving the binoculars.

U.S. Pat. No. 4,029,246 to Robert L. Woodruff describes an adjustable stable camera support for vehicles utilizing the top of the vehicle instrument panel and the front seat cushion as a rest means for the support structure.

U.S. Pat. No. 4,637,536 to Wilbur Wong describes a personal binocular support comprising a mechanically articulared device which fits over the shoulders of the user.

U.S. Pat. No. 5,829,652 to Joanne Denzer and Thom L. Gambaro describes a body-conformable apparatus comprising a platform that is configured to removably and adjustably receive an optical device in an operative position for use by a user. The platform is mounted on a harness worn by the user.

None of these prior art references describe the present invention.

### SUMMARY OF THE INVENTION

It is an object of the present invention to provide an improved adjustable support device for supporting and stabilizing optical equipment such as binoculars, monoculars, cameras and camcorders when used from within a motor vehicle.

### BRIEF DESCRIPTION OF THE DRAWINGS

FIG. 1 is a front perspective view of the device of the present invention in its extended configuration.

FIG. 2 is a front perspective view of the device of the present invention in its contracted configuration.

FIG. 3 shows a side view of the present invention in use.

FIG. 4 is a schematic diagram of a top view of the present invention in its extended configuration.

FIG. 5 is a schematic diagram of a top view of the present invention in its contracted configuration.

FIG. 6 is a schematic diagram of a side view of the present invention showing a variety of possible positions of the distal end of the device.

FIG. 7 is a schematic diagram of a side view of the present invention in its contracted configuration

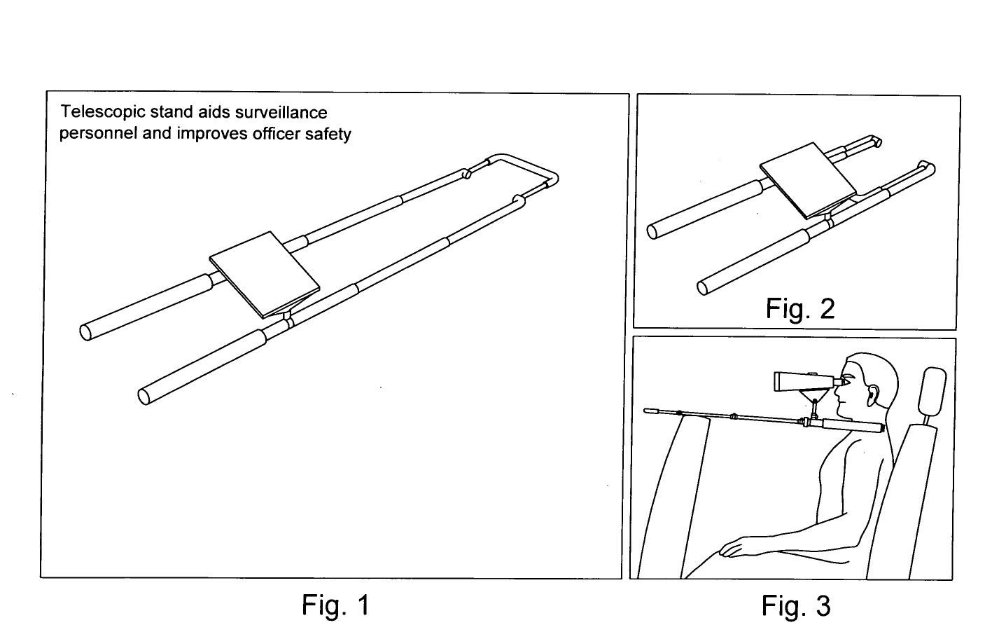

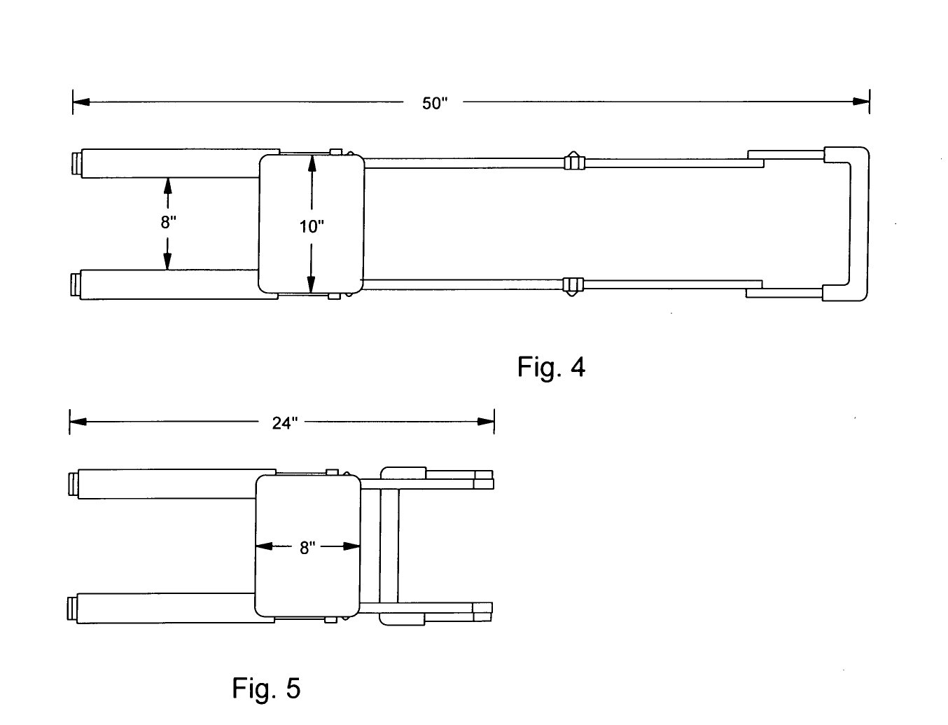

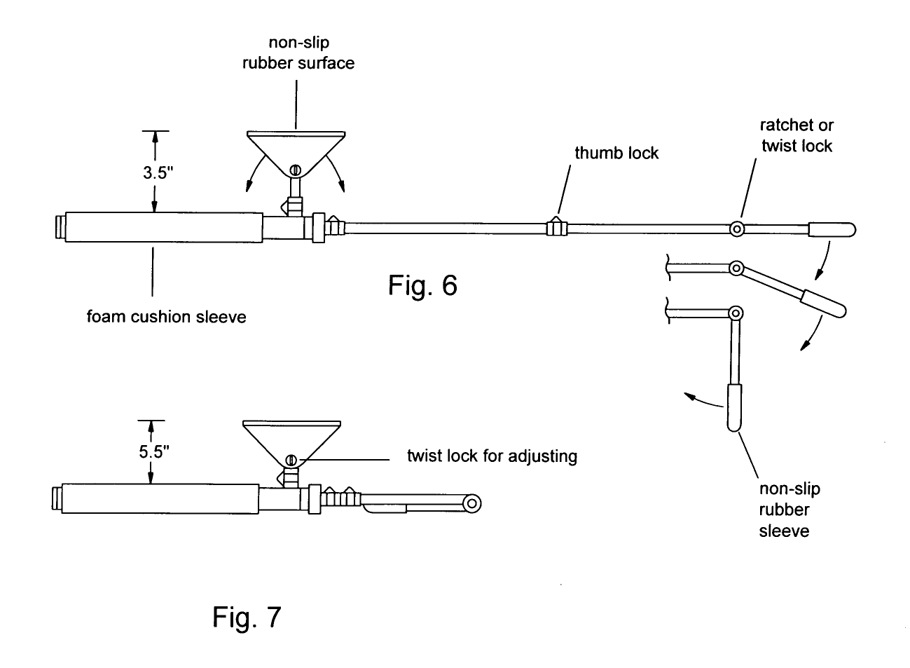

### DETAILED DESCRIPTION OF THE INVENTION

Surveillance is an art, and a useful tool, used for a wide spectrum of purposes. The art of surveillance lies in the concealment of the watcher from the watched, and in the constant vigilance that the watcher must exercise. As a tool, surveillance is the method that enables a police detective, private investigator, DEA agent to gather information and evidence. Surveillance is also the tool that produces startling discoveries in animal behavior, and breathtaking photos of animals in the wild. In terms of the purposes for which surveillance methods are used, these can range from the essential work of law-enforcement and investigation, to the efforts of those who study and photograph birds and other animals, and to photographic journalists and reporters. In each case, the person performing surveillance must be far enough away from the subject to evade detection, yet close enough to observe and record the subject's movements and activities.

To achieve this, the watcher relies on a variety of optical instruments such as binoculars, monoculars, cameras, and camcorders. Two factors come into play here, the combination of which can result in poor results: 1) because of the distances involved, the person engaged in surveillance must employ high-powered binoculars or long telephoto lenses, both of which possess a property known as “optical shake,” a tendency to bounce an image around rather than hold it fixed and steady; and 2) the surveillance must go on for long periods of time, during which the operative becomes fatigued, his or her fatigue only making the optical shaking more pronounced. To make matters even worse, surveillance is often performed from within a motor vehicle, where there is no possibility of using a camera-mount such as a tripod or monopod to support and stabilize the binoculars or camera(s). The present invention, hereinafter referred to as the Q Bino Stand, offers a comfortable, effective support for optical equipment, thus improving the quality of visual surveillance, making the photographic evidence better, and reducing the strain and fatigue of the person performing surveillance.

Through years of experience with surveillance techniques and years of experiencing the phenomenon of “binocular-shake” or “camera-shake” while using high-magnification optics from within a vehicle over long periods of time, the present invention was developed. Simply stated, the Q Bino Stand comprises a lightweight, adjustable support and stabilizing device, analogous to an adjustable tripod or monopod, designed to support and stabilize binoculars, cameras, and camcorders when used from within a motor vehicle. The present invention is to be manufactured by the Photographic Equipment and Supplies industry, Standard Industrial Code 3861. The Q Bino Stand comprises a telescopic stand that expands to different lengths and can be used inside a vehicle, from the driver's seat or passenger's seat, or from the back seat. The rear portion of the stand sits, yoke-like, with an inner width of approximately ten inches, on the user's shoulders, the two supports are padded with a cushioning support foam. From the shoulders, the stand extends forward in two parallel rails that are joined by a cross-member, also padded, at the front end, this end designed to rest on the steering wheel or dashboard or, if the device is to be used from a rear seat, on the headrest of the seat in front. The two rails are equipped with a pivoting, up/down, locking joint approximately ten inches from the terminal end of the rails, thus enabling the user to lower or raise the ends of the rails, as required, for support on steering wheel, dashboard, or headrest. If desired, the device can be powder-coated, matte-black round aluminum tubing. The terminal ends of the rails are also padded with cushioning foam. The support rails or tubes are telescoping, with a fully extended length of approximately fifty inches, and locked and unlocked by two quick-release thumb-tabs like those of a tripod or monopod. Just forward of the shoulder support, a pivoting, swiveling support base, approximately ten inches in width by eight inches in length and topped with a non-slip rubberized coating, provides adjustable support for binoculars, camera, or camcorder. The support base is equipped with a lock for both the swivel for side-to-side adjustment and the tilt for up-and-down adjustment. Further, the stanchion which supports the base can be raised or lowered to a height above the rails of between three and one half inches to about five and one half inches. When fully collapsed, the Q Bino Stand has an outer maximum width of approximately ten inches, and a length of twenty-four inches. The present invention provides elegance, simplicity, and functionality to the support of optical devices. In an alternative embodiment, the device further comprises a spring-loaded tripod-type mounting screw in the center of the support base, as most high-powered binoculars, cameras, telephoto lenses, and camcorders feature tripod-mount sockets.

Use of the Q Bino Stand in field conditions follows. Adjust the front seat to a comfortable position. Unlock and extend the device to the desired length. Adjust the pivoting front or tip of the stand if desired. Place the rear foam portion on top of the shoulders. Place the binoculars, camera, long lens, or camcorder on top of the rubber-coated support base and adjust the short horizontal tube or support stanchion to the desired eye-level. Adjust the flat portion side knobs if required.

Light, durable, compact, adjustable, elegantly designed and built for years of service, the Q Bino Stand, a device for supporting and stabilizing optical instruments such as binoculars, cameras, and camcorders for use on distant subjects from within a motor vehicle, will be primarily of use to law-enforcement officers and agencies, but also of use to others including private investigators and wildlife watchers. For law-enforcement officers, the Q Bino Stand has been designed to support and stabilize the tools of visual surveillance which tend toward binocular-shake or camera-shake at long distances, especially when the user has been holding them for long periods. The Q Bino Stand not only supports and stabilizes optical equipment, but also leaves the user with hands free for other purposes. The Q Bino Stand, in exigent circumstances, can be easily pushed away, freeing the user for whatever motion is required. Equally useful for a variety of occupations which rely on surveillance techniques, the Q Bino Stand is also of great utility to recreational users such as birders and wildlife enthusiasts who prefer to view or study their subjects from within a vehicle. Cleverly conceived and thoughtfully designed, the Q Bino Stand was designed out of need and experience and will find a wide market among law-enforcement officers and agencies, and others engaged in surveillance activities, and wildlife enthusiasts.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A support device for supporting an optical device for use in a motor vehicle, comprising: a lightweight, adjustable support and stabilizing device, comprising a telescopic stand having two parallel rails that expand to different lengths, from the driver's seat or passenger's seat, or from the back seat, and wherein a rear portion of the stand comprising two supports of the stand sits, yoke-like, on the user's shoulders, and from two supports on the shoulders, the stand extends forward in two parallel rails that are joined by a cross-member, at the front end of the stand designed to rest on the steering wheel or dashboard or, if the device is to be used from a rear seat, on the headrest of the seat in front.

2. The device of claim 1 wherein the two rails are equipped with a pivoting, up and down, locking joint approximately ten inches from the terminal end of the rails, thus enabling the user to lower or raise the ends of the rails, as required, for support on steering wheel, dashboard, or headrest.

3. The device of claim 2 wherein the device can be powder-coated, or made from matte-black round aluminum tubing.

4. The device of claim 2 wherein the terminal ends of the rails are padded with cushioning foam.

5. The device of claim 2 wherein the rails are telescoping, with a fully extended length of approximately fifty inches, and locked and unlocked by two quick-release thumb-tabs like those of a tripod or monopod.

6. The device of claim 2 further comprising a pivoting, swiveling support base positioned immediately forward of the shoulder support, to provide adjustable support for binoculars, camera, or camcorder.

7. The device of claim 6 wherein the support base is equipped with a lock for both the swivel for side-to-side adjustment and the tilt for up-and-down adjustment.

8. The device of claim 6 wherein the support base measures approximately ten inches in width by eight inches in length and topped with a non-slip rubberized coating.

9. The device of claim 6 wherein the support base is supported by a stanchion which can be raised or lowered to a height above the rails of between three and one half inches to about five and one half inches.

10. The device of claim 5, that has an outer maximum width of approximately ten inches, and a length of twenty-four inches, when fully collapsed.

11. The device of claim 6, further comprising a spring-loaded tripod-type mounting screw in the center of the support base.

12. The device of claim 1 wherein the optical deice is selected from the group consisting of binoculars, monoculars, cameras, and camcorders when used from within a motor vehicle,

13. The device of claim 1 wherein the inner width of the rear portion measures approximately ten inches.

14. The device of claim 1 wherein the two supports are padded with a cushioning support foam.

15. The device of claim 1 wherein the cross member is padded with a cushioning support foam.
